(19) United States
(12) Patent Application Publication
(10) Pub. No.: US 2005/0046175 A1
(43) Pub. Date: Mar. 3, 2005

(54) Identification card with changeable insert

(76) Inventor: Eric D. Fox, Richmond, VA (US)

Correspondence Address: BAKER BOTTS L.L.P., 2001 ROSS AVENUE, SUITE 600, DALLAS, TX, 75201-2980, US

(21) Appl. No.: 10/650,560

(22) Filed: Aug. 28, 2003

(51) Int. Cl. B42D 15/00; G09F 1/00

(52) U.S. Cl. 283/75; 40/124.01

(57) ABSTRACT

An identification card having a recessed portion or cavity for removably disposing an item. The identification card may have a cover to secure the item within the cavity.

### TECHNICAL FIELD OF THE INVENTION

This invention relates generally to the field of identification cards and more particularly to a method and system for personalizing identification cards.

### BACKGROUND OF THE INVENTION

Consumers frequently use identification cards provided by credit card companies, banks, credit unions, or other entities (“issuers”). These issuers often offer consumers a selection of designs, colors, and/or logos, such as that from a professional sports team or university to allow the consumer to have a more personalized identification card.

Currently, no identification card allows a user to have absolute discretion as to the appearance of the identification card. Typically, consumers are forced to select from pre-approved designs and/or logos selected by the issuer.

### SUMMARY OF THE INVENTION

According to one embodiment of the invention, an identification card is manufactured with a recess, or cavity. This recess or cavity allows a consumer to personalize the identification card with a photograph, a note, or any other item removably disposed in the recess or cavity. According to another embodiment, a method is provided for removably securing an item within an identification card. The method includes creating a recess within the body of the identification card and providing a movable cover at least partially disposed over the recess. The recess is adapted to receive an item and the cover is movable to selectively retain the item in the recess and allow the item to be removed from the recess.

Some embodiments of the invention provide advantages. For example, an identification card with an accessible storage recess allows a consumer to replace or exchange any item placed in the recess of an identification card according to an embodiment of the present invention. The identification card may be more interactive to consumers. The identification card may provide enhanced security. Other advantages may be readily ascertained by one of ordinary skill in the art. Any particular embodiment may have some, none, or all of the enumerated advantages.

### BRIEF DESCRIPTION OF THE DRAWINGS

Reference is now made of the following description taken in conjunction with the accompanying drawings, wherein like referenced numbers represent like parts, in which:

FIG. 1 illustrates an identification card in accordance the prior art;

FIG. 1A illustrates an identification card in accordance with the prior art;

FIG. 2A illustrates an identification card in accordance with an embodiment of the present invention;

FIG. 2B illustrates an identification card in accordance with an embodiment of the present invention;

FIG. 3A illustrates an identification card in accordance with an embodiment of the present invention;

FIG. 3B illustrates an identification card in accordance with an embodiment of the present invention;

FIG. 4 illustrates an identification card in accordance with an embodiment of the present invention;

FIG. 4A illustrates an enlarged partial view of the identification card of FIG. 4 in accordance with an embodiment of the present invention;

FIG. 4B illustrates a card backing in accordance with an embodiment of the present invention;

FIG. 4C illustrates an identification card in accordance with an embodiment of the present invention;

FIG. 4D illustrates an identification card in accordance with an embodiment of the present invention;

FIG. 5 illustrates an identification card in accordance with an embodiment of the present invention; and

FIG. 5A illustrates a cross sectional view of the identification card of FIG. 5 in accordance with an embodiment of the present invention.

### DETAILED DESCRIPTION OF THE DRAWINGS

Embodiments of the invention are best understood by referring to FIGS. 1-5A of the drawings, like numerals being used with like and corresponding parts of the various drawings. In general, certain embodiments of the present invention are directed to combining aspects of a display device in an identification card. “Identification card” is defined as a card identifying its holder and issuer which may carry data required as input for the intended use of the card and for transactions based thereon.” American National Standards Institute 7810-1995, American National Standard for Identification Cards—Physical Characteristics § 1 (1995). Identification cards are more typically known as credit cards, bank cards, check cards, debit cards, and the like. Additional examples of identification cards may include library cards, government identification cards, and driver's licenses. Generally, identification cards, or “cards,” contain embossed letters and numbers, as well as a magnetic stripe containing information regarding the issuer and user of the card. In most instances, the card is made of a plastic or other polymer that allows the issuer to select a design or choose the appearance of the face of the card. Most identification cards are opaque, but at least one manufacturer has created a transparent card. The design of current identification cards is such that a user's choice of designs, logos, and/or appearance of an identification card is very limited. In some cases, a user may select from a limited choice of pre-selected designes. Once a design is chosen, however, it is permanent for the particular card. Thus, embodiments of the present invention may allow a user to personalize the identification card by having an enhanced choice of the appearance of the card at any time.

Standards adopted and approved by the American National Standards Institute (“ANSI”) govern the manufacturer and characteristics of standardized identification cards. These standards have been adopted by most major issuers that provide cards for transactions between consumers and merchants, identification cards for use by agencies, or any other card requiring information to be contained in recordable magnetic stripes on identification cards. For example, the ANSI standard for card materials requires that an identification card be made of polyvinyl chloride and/or polyvinyl chloride acetate or materials having equal or better performance such as polyesters, polyethylenes and polycarbonates. Additionally, the ANSI standard sets forth the location for magnetic stripes manufactured in accordance with the standard. Specifically, the ANSI standards require that the magnetic stripe be located no more than 0.1 inches from a longitudinal edge of an identification card and no more than 0.75 inches from that same longitudinal edge on the back of an identification card incorporating magnetic stripe technology. When embossing is used on an identification card, the embossed area may not be located further than 0.1 inches from the opposite edge of the card from the magnetic stripe and no more than 0.946 inches from the same edge. The standards promulgated by ANSI are based on the characteristics of a card required to be read by a magnetic stripe card reader, automatic teller machine, or other mechanism designed to interpret information incorporated on an identification card through embossing or magnetic stripe technology.

Because the present invention involves the manufacture and/or use of identification cards, the ANSI standards are of particular interest. However, an identification card incorporating elements of the present invention, but failing to conform to ANSI standards for identification cards may still fall within the scope of the present invention, based on the knowledge of one of ordinary skill in the art.

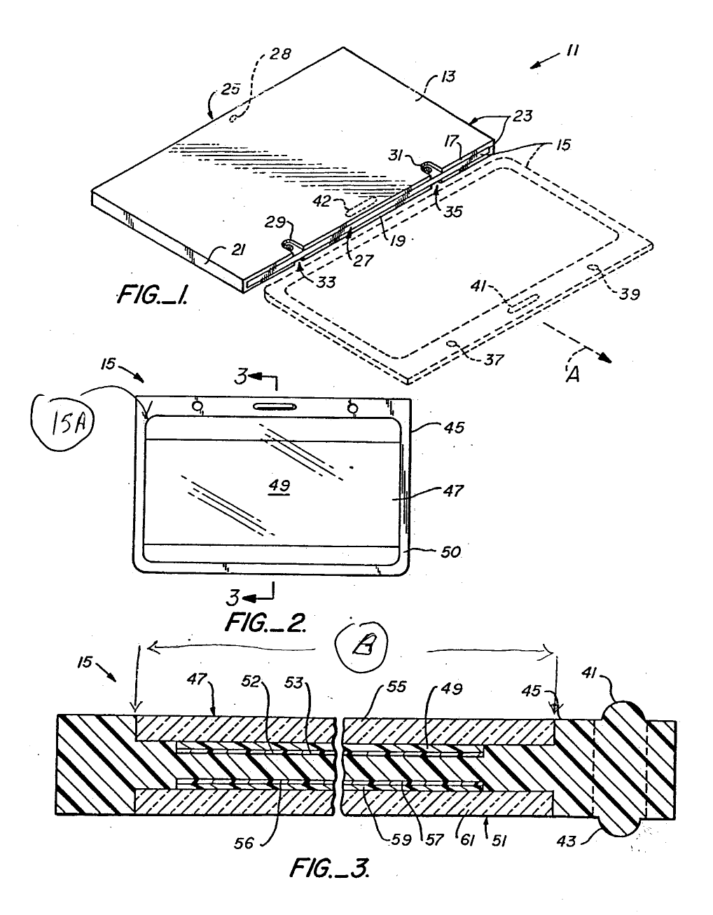

FIGS. 1 and 1A illustrate an identification card, or “card” 100 which may be issued by a credit provider, bank, credit union, other financial institution, or any other issuer which desires to issue an identification card. Card 100 generally comprises embossed numerals 120, personal data 140, magnetic stripe 160, and signature area 180. Other information may be presented on the card such as logos, holographic designs, or pictures (not explicitly shown). Additionally, some cards have embedded smart chip technology (not explicitly shown), which enables information regarding the cardholder or a particular transaction to be transmitted through the credit processing system to the issuer or other third party. FIGS. 2A and 2B illustrate a personalized identification card in accordance with an embodiment of the present invention. Card 200 has long edges 212 and short edges 214. Additionally, face 210 represents the front of the card and back 220 represents the back of the card. Magnetic stripe 230 is located on back 220 of card 200. Cavity opening 240 is located along an edge of card 200. In the embodiment shown, cavity opening 240 is located along short edge 214. However, in certain cases, the cavity

opening could be located along one of the long edges 212. Cut out portion 242 is located in the area of cavity opening 240 along short edge 214 and cavity 260 extends within the body of card 200 to allow the insertion of an item 250. Cut out portion 242, located along short edge 214 corresponding to cavity opening 240, allows a user to more easily remove an item 250 inserted into cavity 260 of card 200. Additionally, face 210 of card 200 may be transparent, partially transparent, partially opaque with a transparent portion corresponding to cavity 260, or completely opaque.

After item 250 is inserted into cavity 260 through cavity opening 240 along short edge 214, the user may be able to view the item 250 through a transparent portion corresponding with cavity 260 in face 210. Cut out portion 242 along short edge 214 corresponding to cavity opening 240 allows a user to remove an item 250 inserted into cavity 260 through opening 240.

FIGS. 3A and 3B illustrate an identification card having an opening in accordance with an embodiment of the present invention. Card 300 has a face 310 and a back 320. Long edges 312 are on opposites sides of card 300 from one another as are short edges 314. Magnetic stripe 330 is disposed parallel to long edges 312 on back 320 of card 300. Additionally, a cavity opening 340 provides access to cavity 360. Cavity opening 340 is disposed along a short edge 314. However, the cavity opening may, in some cases, be disposed along a long edge 312. An endcap or plunger assembly 342 is operable to secure an item 350 disposed within cavity 360 through opening 340. Plunger assembly 342 has a hinge 348 rotatably attaching plunger assembly 342 to card 300, a tab 346 which enables a user to secure plunger assembly 342 along an edge 314 of card 300 to secure item 350 in cavity 360, and a plunger portion 344 which is slightly smaller than cavity opening 340 to allow plunger portion 344 to be inserted in cavity 360 through cavity opening 340. Tab 346 allows a user to rotatably open and close plunger assembly 342 so that a user can insert and remove an item 350 into cavity 360. Additionally, plunger assembly 342 may be an endcap that can be removably disposed within opening 340 (not explicitly shown). This embodiment differes in that endcap 342 is not rotatably attached to card 300 by hinge 348.

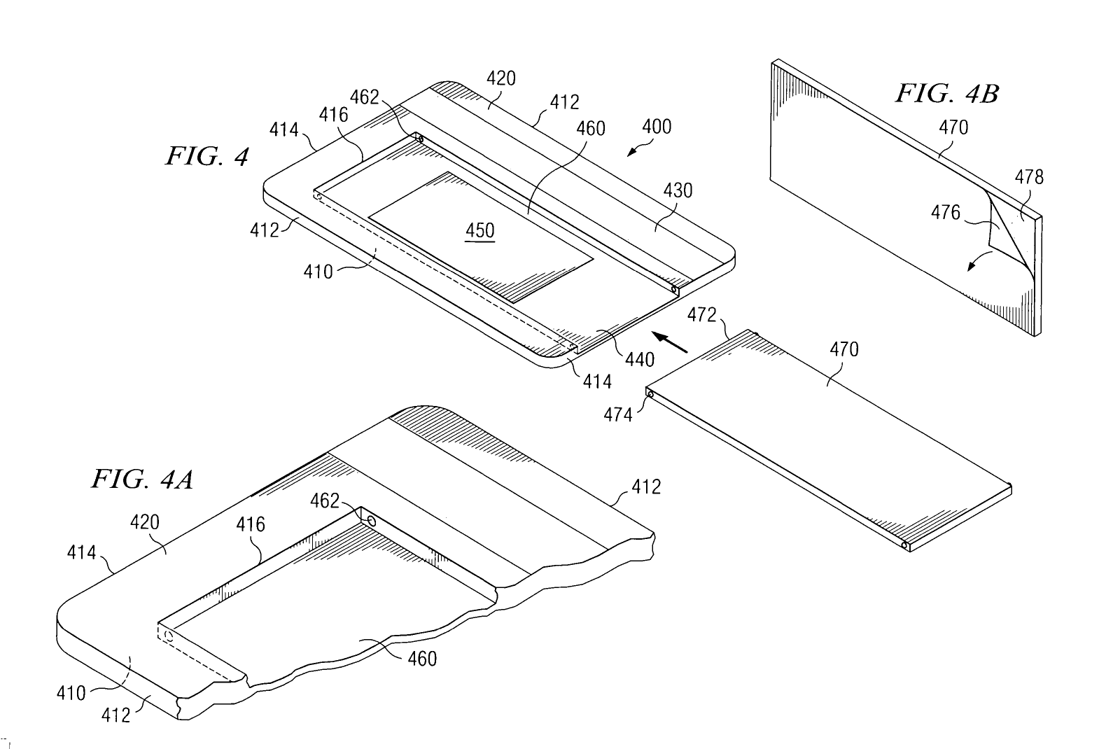

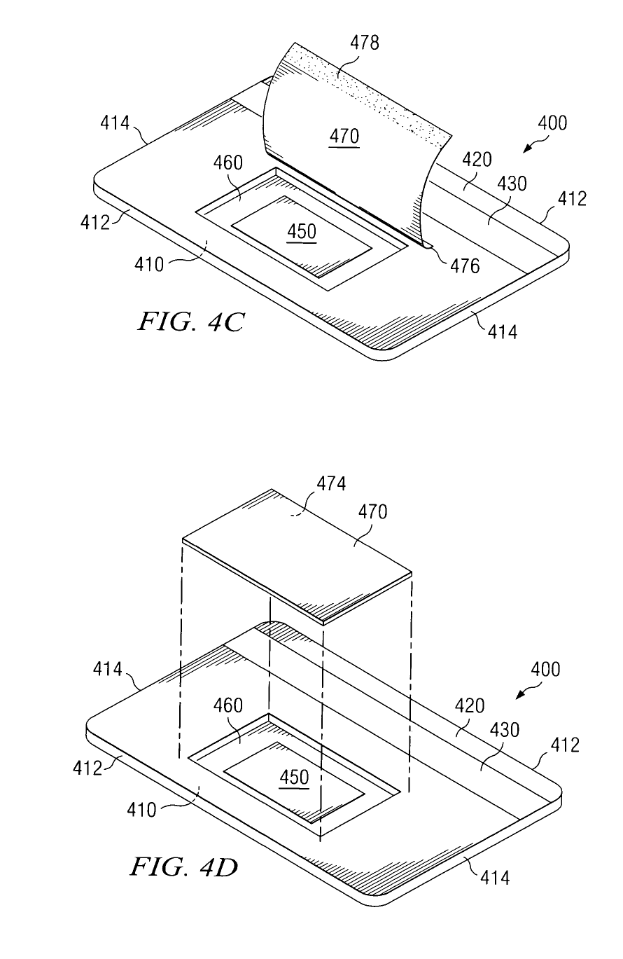

FIGS. 4 and 4A represent an embodiment of the invention wherein card 400 has a face 410, a back 420, long sides 412 and short sides 414. Additionally, magnetic stripe 430 is disposed on back 420 of card 400 and contains a user's personal information as well as that of an issuer. Cavity 460 is disposed parallel with long sides 412 within a portion of the back 410 of card 400. Cavity stop 416 is disposed along a short side 414 opposite of opening 440 which disposed on the opposing short side 414. Although opening 440 is shown disposed along a short side 414, it may be disposed along a long side 412 instead. Cavity stop 416 is operable to stop a slidably disposed card backing 470 when card backing 470 is disposed within cavity 460 to secure an item 450 placed in cavity 460. Card backing 470 has a lead edge 472 and a locking device 474. Locking device 474 is operable to secure card backing 470 in cavity 460 when card backing 470 is slidably disposed into cavity 460 through opening 440. Locking device 474 may be a portion of card backing 470 where the distance as measured from short side to short side of card backing 470 isslightly larger than the remaining width of card backing 470 so that when locking device 474 engages depressions 462 in cavity 460, card backing 470 is held securely into place.

FIG. 4B illustrates an alternative embodiment of an identification card backing wherein a card backing 470 has an adhesive strip 478 disposed on a side of card backing 470 so that an item 450 may be secured to the card backing which, in turn, may be secured to card 400 within cavity 460. In an alternative embodiment, card backing 470 may have an adhesive strip disposed along the edges and secure an item 450 to the back 420 of card 400 (not explicitly shown). Card backing 470 with adhesive portion 478 may also have a cover portion 476 operable to preserve adhesive strip 478 until an item 450 is desired to be placed on the adhesive strip 478, the card backing 470 then disposed within or adjacent to cavity 460 and secured to card 400 with any remaining adhesive.

FIG. 4C illustrates yet another embodiment of a card backing 470 wherein the card backing 470 may be a flap at least partially secured to back 420 of card 400. The flap may be flexible or rigid. Adhesive strip 478 is preferably disposed on the card backing 470 so as to engage the back 420 of card 400 when an item 450 is disposed within cavity 460 and card backing 470 is pressed over cavity 460.

FIG. 4D illustrates an embodiment wherein the card backing 470 may be secured over cavity 460. In this embodiment, card backing may have an adhesive, or may be manufactured of a material that is inherently adhesive to plastic, such as a smooth plastic that adheres to smooth surfaces such as glass or smooth plastics without the need for additional adhesive material. Card backing 470 is preferably larger in surface area than the surface area of cavity 460, and has an adhesive side 474 that may have adhesive 478 disposed thereon, or adhesive side 474 may be inherently adhesive. When card backing 470 is placed over cavity 460, card backing 470 adhesively engages back 420 of card 400 to secure an item 450 placed within cavity 460.

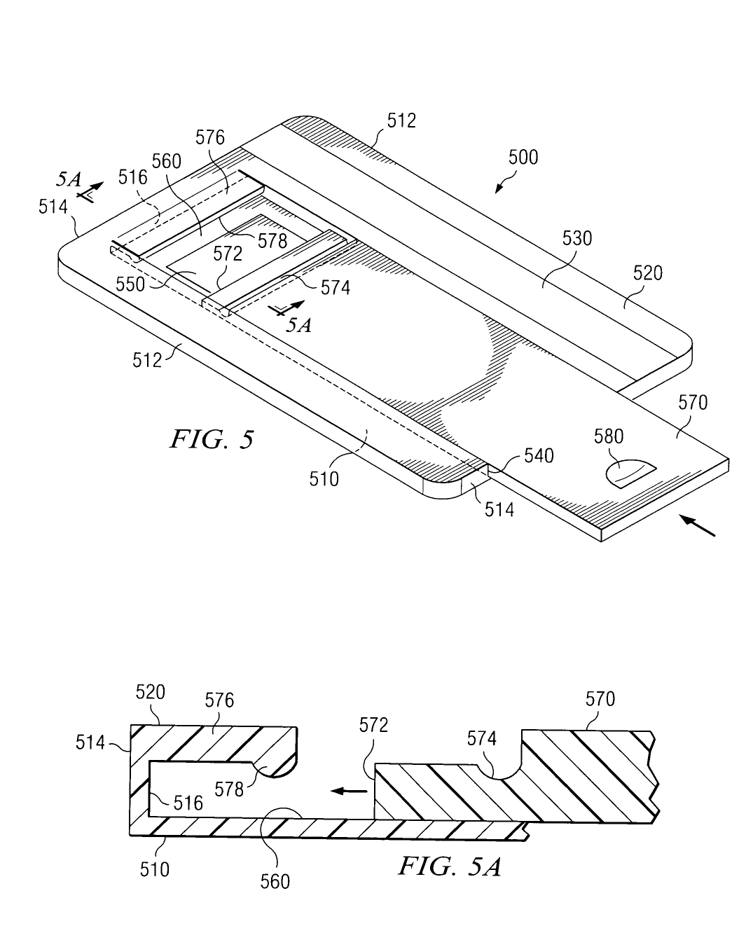

FIGS. 5 and 5A illustrate an embodiment of the invention wherein card 500 has a face 510, a back 520, long sides 512 and short sides 514. Additionally, magnetic stripe 530 is disposed on back 520 of card 500. Cavity 560 is preferably disposed parallel to long sides 512 within a portion of the back 510 of card 500. Cavity stop 516 and card latch 576 are disposed on one short side 514. Cavity opening 540 is preferably disposed on an opposite short side 514 of card 500 and is operable to receive a card backing 570, which may be slidably disposed within cavity 560. However, opening 570 may be disposed on a long side 512. Card backing 570 may include a lead edge 572 and a groove 574 which, when card backing 570 is inserted in cavity 560 through cavity opening 540, may be substantially parallel to short sides 514. Groove 574 is preferably disposed a distance from lead edge 572 of card backing 570 to allow latch 576, with distal portion 578, to engage groove 574 when lead edge 572 of card backing 570 is fully disposed within cavity 560.

During operation, latch 576 is preferably flexible, so that when an item 550 is disposed within cavity 560, distal portion 578 of latch 576 engages lead edge 572 of card backing 570, latch 576 allows card backing 570 to slide beyond distal portion 578 until distal portion 578 of latch 576 is disposed at least partially within groove 574 to prevent card backing 570 from being removed from cavity 560, and to preferably secure item 550 into place.

Although the present invention has been described in detail, it should be understood that various changes, substitutions, and alterations may be made, without departing from the spirit and scope of the present invention as defined by the claims.

1. An identification card comprising:
a recess operable to receive an item personally selected by a cardholder of the identification card to customize the identification card according to one or more particular personal preferences of the cardholder, the recess permitting the item to be inserted into and removed from the recess by the cardholder.

2. The identification card of claim 1, further comprising a cover, the cover operable to maintain the item within the recess.

3. The identification card of claim 2, wherein the cover is a removable endcap.

4. The identification card of claim 3, wherein the endcap is hinged.

5. The identification card of claim 3, wherein the endcap is removably disposed within the recessed portion.

6. The identification card of claim 1, wherein at least a portion of the identification card is at least partially transparent, the at least partially transparent portion operable to make the item visible through a face of the identification card.

7. An identification card comprising:
a cavity in the identification card, the cavity being operable to receive an item personally selected by a cardholder of the identification card to customize the identification card according to one or more particular personal preferences of the cardholder; and
a cover operable to secure the item in the cavity and operable to permit the item to be inserted into and removed from the cavity by the cardholder.

8. The identification card of claim 7, wherein the cavity is disposed on a first face of the identification card.

9. The identification card of claim 8, wherein a second face has an at least partially transparent portion to allow viewing of the item in the cavity.

10. The identification card of claim 7, wherein the cover has an adhesive portion on a first side, the adhesive portion operable to secure the cover to the identification card.

11. The identification card of claim 10, wherein the cover is a flap at least partially attached to a face of the identification card adjacent to the cavity, the cover operable to secure the cavity with the adhesive portion.

12. The identification card of claim 10, wherein the cover has a surface area greater than the surface area of the cavity, the cover operable to adhere to the identification card and cover the cavity.

13. The identification card of claim 7, further comprising a securing mechanism, the securing mechanism operable to affix the cover to the identification card.

14. The identification card of claim 13, the securing mechanism comprising a groove in the cavity of the identification card, the groove operable with the cover to removably secure the cover to the identification card.

15. The identification card of claim 13, the securing mechanism comprising:
a distal portion along an edge of the cover; and
a recessed portion in the cavity, the recessed portion operable to receive the distal portion of the cover to secure item in the identification card.

16. A method for a securing an item within an identification card comprising:
creating a recess within the body of the identification card, the recess being operable to receive an item personally selected by a cardholder of the identification card to customize the identification card according to one or more particular personal preferences of the cardholder; and
covering the recess with a movable cover to secure the area bounded by the movable cover and the recess, the movable cover operable to secure the item in the recess and operable to permit the item to be inserted into and removed from the recess by the cardholder.

17. The method of claim 16, wherein the identification card comprises a face that is at least partially transparent.

18. The method of claim 16, wherein the cover is slidably secured to the identification card.

19. The method of claim 16, wherein the cover is secured to the identification card with an adhesive.

20. The method of claim 16, further comprising securing the cover to the identification card with a hinge, the hinge operable to allow the cover to secure the item in the recess.

21. The method of claim 16, wherein the cover comprises a plunger, the plunger operable to be inserted in the recess to secure the item.

22. The method of claim 21, further comprising attaching the plunger to the identification card with a hinge, the hinge operable to allow rotation of the plunger into the recess.

23. An identification card comprising:
a recess operable to receive an insert, the recess permitting the insert to be inserted into and removed from the recess by a cardholder of the identification card; and
the insert coupleable to a picture to permit the picture to be inserted into and removed from the recess by the cardholder, the picture being personally selected by the cardholder to customize the identification card according to one or more particular personal preferences of the cardholder.

24. The identification card of claim 23, comprising a cover operable to maintain the insert within the recess.

25. The identification card of claim 24, wherein the cover is a removable endcap.

26. The identification card of claim 25, wherein the endcap is hinged.

27. The identification card of claim 25, wherein the endcap is removably disposed within the recessed portion.

28. The identification card of claim 23, wherein the cover has an adhesive portion on a first side, the adhesive portion operable to secure the cover to the identification card.

29. The identification card of claim 28, wherein the cover is a flap at least partially attached to a face of the identification card adjacent to the recess, the cover operable to secure the recess with the adhesive portion.

30. The identification card of claim 28, wherein the cover has a surface area greater than the surface area of the recess and is operable to adhere to the identification card and cover the recess.

31. The identification card of claim 24, comprising a securing mechanism operable to affix the cover to the identification card.

32. The identification card of claim 31, the securing mechanism comprising a groove in the recess of the identification card, the groove operable with the cover to removably secure the cover to the identification card.

33. The identification card of claim 31, the securing mechanism comprising:
a distal portion along an edge of the cover; and
a recessed portion in the recess, the recessed portion operable to receive the distal portion of the cover to secure item in the identification card.

34. The identification card of claim 24, wherein the cover is slidably secured to the identification card.

35. The identification card of claim 24, wherein the cover is secured to the identification card with an adhesive.

36. The identification card of claim 24, further comprising securing the cover to the identification card with a hinge, the hinge operable to allow the cover to secure the item in the recess.

37. The identification card of claim 24, wherein the cover comprises a plunger, the plunger operable to be inserted in the recess to secure the item.

38. The method of claim 37, wherein the plunger is attached to the identification card with a hinge operable to allow rotation of the plunger into the recess.

39. The identification card of claim 23, wherein the recess is disposed on a first face of the identification card.

40. The identification card of claim 28, wherein a second face has an at least partially transparent portion to allow viewing of the picture when the picture is in the recess.
